(19) United States
(12) Patent Application Publication
(10) Pub. No.: US 2004/0176083 A1
(43) Pub. Date: Sep. 9, 2004

(54) Method and system for reducing distractions of mobile device users

(75) Inventors: Stephen Shiao, Coral Springs, FL (US); Patrick Doran, Plantation, FL (US); Michael Adam Heck, Davie, FL (US)

Correspondence Address: FLEIT, KAIN, GIBBONS, GUTMAN, BONGINI, & BIANCO P.L., 551 N.W. 77TH STREET, SUITE 111, BOCA RATON, FL, 33487, US

(73) Assignee: MOTOROLA, INC., SCHAUMBURG, IL

(21) Appl. No.: 10/373,946

(22) Filed: Feb. 25, 2003

(51) Int. Cl. H04M 3/42

(52) U.S. Cl. 455/417; 455/414.1

(57) ABSTRACT

A method and a computer readable medium for reducing distractions of a mobile device user include determining, if a mobile device is moving; and if the mobile device is moving, then selecting a message for notifying a caller that a called party is unavailable. Determining is done from the viewpoints of a mobile device and a mobile service provider. Preferably, determining if the mobile device is moving includes checking with a GPS system if coordinates are changing within a given limit. The mobile device includes a controller; a detector coupled to the controller for detecting if the mobile device is moving in a given region; and means for selecting a message for notifying a caller that a called party is unavailable. In one embodiment, the detector is a GPS receiver.

### FIELD OF THE INVENTION

The present invention generally relates to telephonic communications of mobile devices and more particularly relates to reducing distractions of mobile device users.

### BACKGROUND OF THE INVENTION

Wireless communications systems have become very popular worldwide. Many users carry their cell phones while moving. The mobility offered by wireless phones has received popular success. People use mobile phones both while moving in a car or a train and while sitting at a café.

Notwithstanding the popularity of mobile devices, consider a situation when a mobile device owner does not want to be distracted. Such situations include: when the mobile device (device) user is operating vehicles including a motor vehicle, a bicycle, boat, and an aeroplane; and when the mobile device user is operating heavy equipment. For example, a caller may not know that the user is driving and does not want to be interrupted. Thus, often times, the mobile device (e.g., cell phone) rings while a user is driving, which leads to an unsafe driving environment. Accordingly, a need exists to provide a way to reduce the distractions of a cell phone carrier while involved in the aforementioned tasks.

Further, consider a situation when the user wishes to also inform the caller that the user is driving or is otherwise temporarily unavailable. There is no conventional automated system that is customized to inform the caller about the situation. Accordingly, a need exists to provide a way to automatically inform the caller that the user is driving.

In addition, certain counties have laws that prohibit using a cell phone while driving a vehicle. The driver may not know about a specific law and may inadvertently leave the cell phone on. However, when the driver hears a ring, the driver may instinctively answer the phone and start talking, which is unlawful. Accordingly, a need exists to provide a way to automatically answer the call without any human intervention on the part of the driver.

Moreover, consider a mobile employee answering a phone call while driving during the scope of the employee's duties. Lawsuits are pending in several jurisdictions where employers are being held liable for their employees' distractions while driving. Statistically, if the employee is distracted, the risk of motor vehicle accidents increases. Naturally, the employing company seeks to protect itself from this type of liability. Accordingly, a need exists to provide a way to automatically employees from answering the calls while driving.

In addition, consider a situation when the user leaves the cell phone on in an airplane. FAA prohibits the operation of cell phones while the plane is moving including taxiing on the ground or while in the air. Again, the cell phone user may not be aware that the cell phone is inadvertently left “on”. Accordingly, a need exists to provide a way to automatically stop the cell phone from ringing in a moving aeroplane.

Therefore a need exists to overcome the problems with the prior art as discussed above.

### SUMMARY OF THE INVENTION

According to one embodiment of the present invention, a method and a computer readable medium for reducing distractions of a mobile device user include determining, if a mobile device is moving; and if the mobile device is moving, then selecting a message for notifying a caller that a called party is unavailable. In other embodiments, the determination is done from the viewpoints of a mobile device and a mobile service provider.

According to another embodiment of the present invention, a mobile device includes a controller; a detector coupled to the controller for detecting if the mobile device is moving in a given region; and means for selecting a message for notifying a caller that a called party is unavailable.

### BRIEF DESCRIPTION OF THE DRAWINGS

FIG. 1 is a block diagram of an end user mobile device for implementing the method, according to the present invention.

FIGS. 2A-2C are flow diagrams showing the method, operating on the end user mobile device of FIG. 1, according to the present invention.

FIGS. 3A-3B are schematic and block diagrams of a service provider's network, in communication with and operating on the end user device of FIG. 1 for implementing the method, according to the present invention.

FIGS. 4A-4C are flow diagrams showing the method (from a service provider's viewpoint), operating on the service provider's network of FIGS. 3A-3B, according to the present invention.

### DETAILED DESCRIPTION

Advantageously, with the present invention, the user is not distracted or overburdened by sensory overload in the course of driving, which is conducive to a safe driving environment. Accordingly, by using the present invention, as opposed to conventional mobile devices, the user can continually pay attention to the road while driving.

In one embodiment, the present invention is implemented as an enhancement to the current answering system in that it informs the caller that the user is driving, while preempting the call, thereby reducing the distractions of the driver.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

General Mobile Communications Overview

Referring generally to mobile communications, a typical cellular mobile radio telephone system is controlled by at least one mobile switching center (also known as “mobile telephone switching office”), at least one base station, and at least one mobile device. The mobile switching center constitutes an interface between the radio system and the public switching telephone network. The base station transmits information between the mobile devices and the mobile switching centers. Calls to and from mobile subscribers are switched by the mobile switching center.

The mobile switching center also provides all signaling functions needed to establish the calls. In order to obtain radio coverage of a geographical area, a number of base stations are normally required. This number may range from one base station to one hundred or more base stations in normal systems. The area is divided into cells, where each cell may either be serviced by a base station or may share a base station with a number of other cells.

Currently, cellular radiotelephone service is provided in the 825 to 845 MHz and 870 to 890 MHz frequency bands. The higher-frequency band is used for “down-link” transmissions from the “cell site” for reception by the subscriber. The cell site is the location of the transmitter, or, more specifically, the location of the antenna from which transmissions are effected for the cell. The lower frequency band is used for “up-link” transmissions from the subscriber in the cell for reception by the receiving equipment which is also located at the cell site.

Each frequency band assigned to the cellular radiotelephone system is divided into two groups, with one group being reserved for the local telephone company and the other group being franchised to a completing service provider. Each cellular channel has a 30 Kilohertz bandwidth, allowing for 666 sequentially numbered channels, with channels 1 through 333 being allocated to one service provider and channels 334 through 666 being allocated to the other service provider.

Communications between the radio base stations within the system and the mobile devices within the system are divided into a plurality of voice or speech channels and at least one access or control channel, which may be either analog or digital and which may have any data rate. An illustrative one of such access or control channel is referred to as the forward control channel (FOCC).

Each mobile device which is operating within a cellular communications system is located when a call is received by the system which is intended for that station. A mobile device is located by broadcasting a paging signal directed to the mobile device and requesting it to respond if it receives the page. When the mobile broadcasts its page response signal to the page signal it is then placed on a voice channel by the base station and the call intended for the mobile can be connected to it through that voice channel. Cellular telecommunications systems employ a control channel such as the forward control channel (FOCC) as the means by which paging signals are broadcast into the various cells of the system in order to locate a particular mobile device.

The control channel, such as the FOCC, is typically restricted to a rate on the order of 8-10 K bits per second which is a speed limitation imposed by the technology used in that implementation. The control channel may also be utilized to transmit other messages to the mobile devices, including, for example, voice channel designations, directed retry orders, system ordered rescan signals and system overhead message trains each of which use substantial control channel capacity each time they are transmitted.

Paging provides the ability to locate a mobile device's whereabouts within the exchange in order to set up a call to that mobile device. More specifically, the paging process in mobile cellular radio systems, attempts to identify the specific cell containing that mobile, as described above in connection with the paging process. During the execution of the process, the mobile switching center (MSC) searches for the mobile by sending a sequence of paging messages on the FOCC of the system and awaits a page response. The page message is transmitted to all of the cell sites covering the entire service area of the system in order to ensure that the mobile is located regardless of where it might be within the system.

In present systems, when a page remains unanswered by the mobile device which is sought, the page must be repeated. This repetition can be either within a location area previously paged or within the entire service area (SA) of the system. The present practice within cellular radio systems is to employ the paging process to handle incoming page requests on a “first come, first served” basis. Depending upon whether the location area (LA) of the requested mobile device is known or not, the amount of paging capacity allocated to serve a particular page request is the same. In other words, if the LA of the mobile device is known, then the first page attempt is within the LA. Otherwise, the page attempt is within the service area (SA) which includes all of the LAs within the exchange. If no response is received to the page, the page is repeated either within the LA itself or within the SA.

When attempting to route a call to a mobile device, the MSC specifically knows in which cell the mobile device is located. In accomplishing the task of locating the mobile, the MSC pages the mobile device in the location area where the mobile device last registered. This prevents a global or system-wide page wherein all the cells within an exchange are paged simultaneously. If the mobile device does not answer the page request in the registered location area of its last registration, only then is service area or global paging required in order to locate the mobile.

Locating the mobile phone is based on the concept of mobile registration. Mobile registration is the process by which a mobile phone becomes listed as being present in the service area of one of the mobile exchanges in a mobile telephone service network. It is recognized that one purpose of mobile registration is to permit calls to a mobile phone to be automatically delivered even though the mobile phone may be moving from place to place through a network of cellular systems.

It is also recognized that mobile phone registration according to EIA Standard IS-3D is affected by interactions between the cellular system and the mobile phones operating in its service area. One such interaction is called “autonomous registration” and it is controlled by the cellular system through certain information transmitted to the mobile phones. This information is in the form of an overhead message train (OMT), which is transmitted on paging channels throughout a cellular system service area, normally once each second approximately. The OMT includes a system parameter overhead message including station and registration related messages, and optionally, several other messages of which the registration identification message and the registration increment message relate to the autonomous registration process.

Registration may be enabled or disabled individually for each class of mobile phone, e.g., home/roam (explained below), via control bits in the system parameter overhead message. The system parameter overhead message also contains the identification number of the serving cellular system from which the mobile phone determines whether it is a “home” or a “roam” mobile phone. Each mobile phone contains, in its internal memory, an entry indicating the identity of its home cellular system and an entry indicating the cellular systems (which may be the home cellular system) in which it has most recently registered successfully. It also stores a value for the cellular system used to determine when it is scheduled to re-register in that cellular system.

Operation from End User Mobile Device Viewpoint

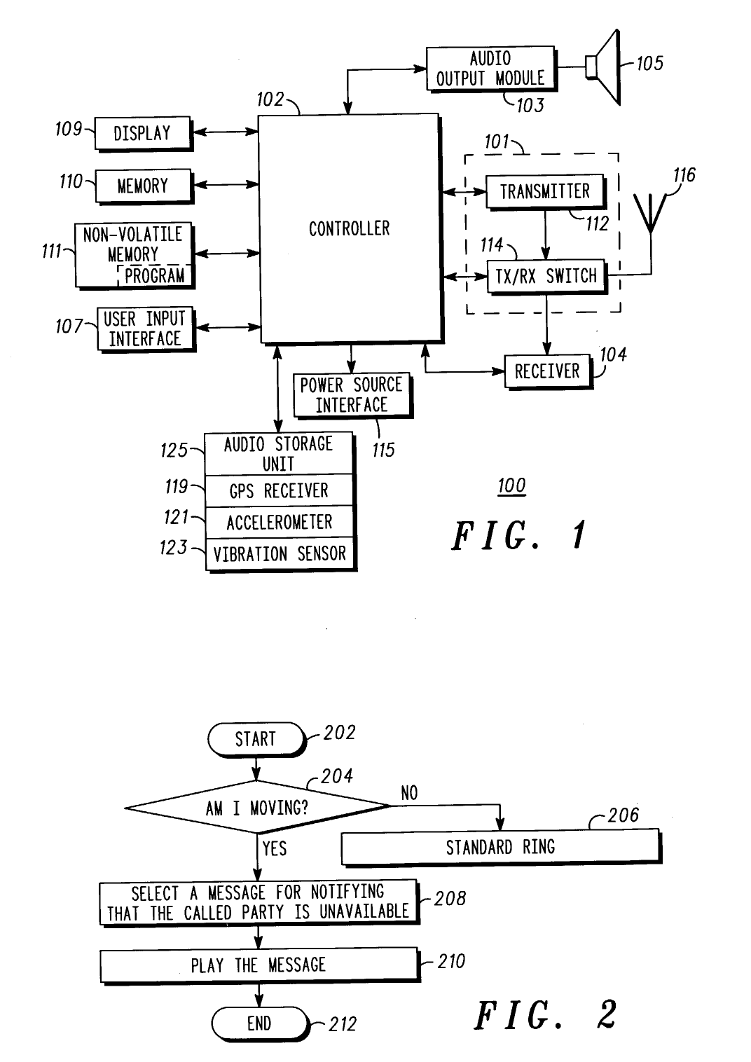

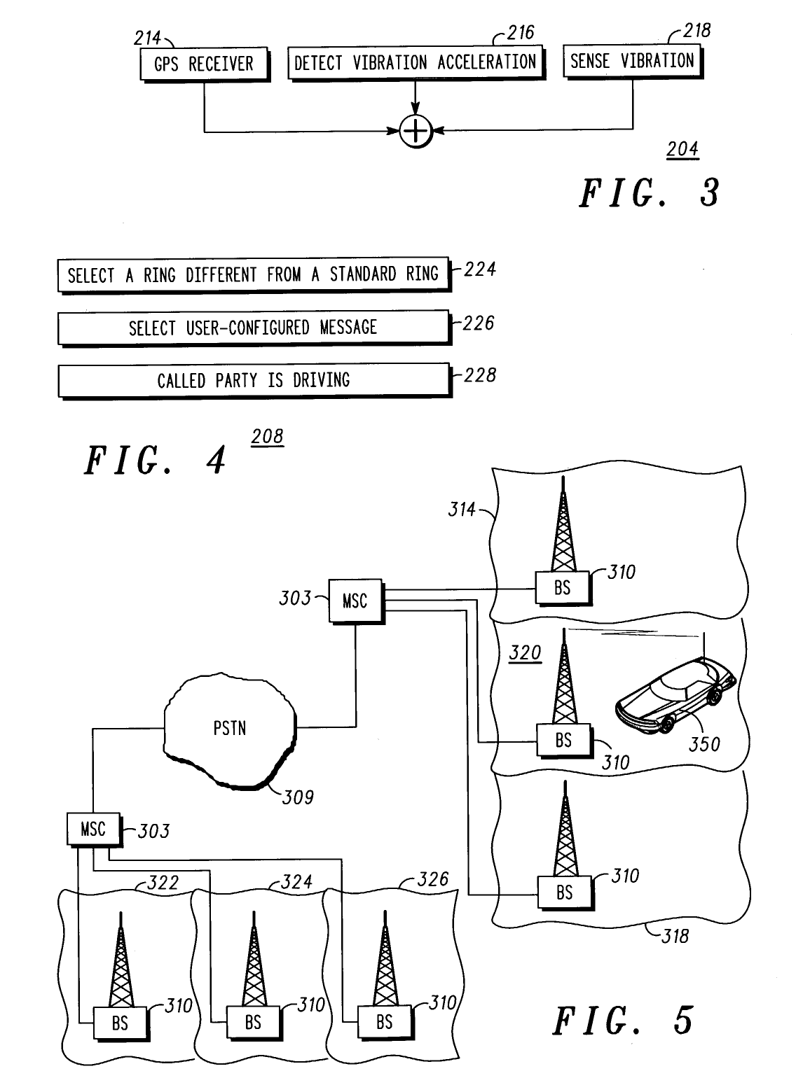

Referring now to the drawings, FIG. 1 shows the block diagram of an end user mobile device (such as a cell phone) located in a cellular network for implementing the method, according to the present invention. FIGS. 2A-2C are flow diagrams showing the method, operating on the end user of FIG. 1, according to the present invention.

The end user device 100 includes a controller 102, a memory 110, a non-volatile (program) memory 111 containing predefined configuration routines. The end user device 100 also includes other units for implementing the method of the present invention, as described below.

In “receive” mode, the controller 1102 couples an antenna 116 through a transmit/receive (TX/RX) switch 114 to a receiver 104. The receiver 104 decodes the received signals and provides the decoded signals to the controller 102. In “transmit” mode, the controller 102 couples the antenna 116, through the switch 114 to a transmitter 112. The controller 102 operates the transmitter 112 and receiver 104 according to instructions stored in the program memory 111.

Further, the controller 102 is coupled to a user input interface unit 107 (such as a key board), a display unit 109 (such as a liquid crystal display), the memory 110, an audio output module 103, a transducer 105, and to a non-illustrated power source through a power source interface 115.

The following units can realize the reception/transmission of signals via the antenna 116: a power amplifier, a driving amplifier, an up/down converter, a buffer, an automatic gain control amplifier, and a radio frequency band pass filter. The power amplifier amplifies signals to transmit the amplified signals to a base station via the antenna. The drive amplifier provides the power amplifier with signals to effectively perform the amplification. The up/down converter shifts (up/down) the frequencies upon transmission/reception.

The user input unit 107 has several keys (including function keys) for performing various functions. The input unit 107 outputs data (to the controller 102) based on the keys depressed by the user. Accordingly, the controller 102 fetches the program instructions stored in the program memory 111 and executes the program instructions. The display unit 109 is used for displaying the status of the end user device and the progress of the program being executed by the controller 102.

The end user mobile device (which can be purchased from Motorola, for example) 100 also contains a detector 118 coupled to the controller 102 for detecting if the mobile device 100 is moving (or is in a given region) and an audio storage unit 125 for selecting a message for notifying a caller that a called party is unavailable. In another embodiment, the audio storage unit is a part of the memory 110. When the caller initiates a call to the called party (mobile device user), the call is processed and the mobile device 100 receives the call through the antenna 116. At step 204, a mobile device provider (for example, Motorola) determines if the mobile device 100 is moving (with the detector 118).

There are various embodiments which are discussed below for determining if the end user device is moving. These embodiments include additions to the end user mobile device such as GPS and vibration sensors. Other embodiments include using the cellular providers' infrastructure such as E911 and fading profiles. Each of these exemplary embodiments is now described along with the custom message setup.

Location Embodiment Using GPS Receiver Hardware

In one embodiment, the determining step 204 is performed by a GPS receiver 119 (at step 214) that computes the geographic coordinates (and detects the changes) of the mobile device 100. The GPS receiver 119 is for example provided by a commercial supplier such as General Motors, and is coupled with a GPS network. GPS is one example of a location system using time of arrival and triangulation for location is a satellite-based system. Commercial services such as Omnitracs™ operated by Qualcomm and On-Star™ operated by “General Motors” use GPS. GPS provides accurate position determination (with about 100 meters error) from a time-based signal received simultaneously from at least three satellites. The ground-based GPS receiver 119 is coupled with a mobile device 100 to be located determines the difference between the time at which each satellite transmits a time signal and the time at which the signal is received and, based on the time differentials, determines the mobile device's 100 location.

Location Embodiment Using Accelerometer Hardware

In another embodiment, the determining step 204 is performed by an accelerometer 121 (at step 216) that detects the acceleration of the vehicle in which the mobile device 100 is located.

Referring to accelerometers, they are employed in various applications to detect disturbances, such as a shock or periodic vibration. An example is a disk drive, which employs an accelerometer to detect disturbances affecting an actuator arm while attempting to maintain a head over a centerline of a track. The accelerometer, well known to those skilled in the art, detects acceleration and provides a voltage output that is proportional to the detected acceleration.

Conventional accelerometers include a sensor for detecting accelerations, and signal processing circuitry for converting the sensor signals into acceleration signals representing a direction and magnitude of the detected accelerations. The acceleration signals are typically generated as digital signals for processing by other control circuitry, such as a servo controller in a disk drive. A conventional Analog-to-Digital converter (ADC) is typically employed to convert the analog sensor signals into digital sensor signals, and the digital sensor signals processed to generate the digital acceleration signals.

Another example of an accelerometer is “G-Link” (by MicroStrain), a high-speed accelerometer node, designed to operate as part of an integrated wireless sensor network system. These small, fast, wireless data recording systems can be used to monitor tilting, vibrating, and rotating machinery, equipment, and structures. Another example is “Micro Datalogging Transceiver” (by MicroStrain), which can be used similarly for detecting an object's acceleration, vibration, impact, torque, angular motion, temperature, and so on.

Location Embodiment Using Vibration Sensor Hardware

In another embodiment, the determining step 204 is performed by a vibration sensor 123 (at step 218) that senses the vibrations of the mobile device 100. Analog Devices, Inc. of Norwood, Mass. offers integrated microelectrical-mechanical systems (IMEMS) that work advantageously with the present invention. Other types of sensors may also be utilized.

Custom Message

If it is determined that the mobile device 100 is not moving, the call is processed in the normal manner by generating a standard ring (at step 206). If it is determined that the mobile device 100 is in a moving vehicle, a message is selected (at step 208) for notifying the caller that the called party is unavailable. The selected message is at least one of the following:

A ring (as heard by the caller) different from a standard ring (step 224).

A user-customized message (step 226) (such as “I am driving. Please leave a message and I will call back shortly.” or “I am busy. Please leave a message and I will call back shortly.” or “I am on vacation. In my absence, please call my supervisor.”, and more).

An automated standard message (step 228) (such as “The called party is driving. Please leave a message and the called party will call you back as soon as possible.”).

User Customization of Messages

The customization of the messages is performed by the user (“called party”) as follows. The user is presented with a predefined configuration routine of messages by the controller 102. When the first message that is presented (via the audio output module 103 and transducer 105) is not satisfying to the user, the user informs the controller 102 via the keyboard 107 that the user needs more choice. Then, the controller 102 executes the program instructions stored in the program memory 111. Then, the user is presented (via the audio output module 103 and the transducer 105) with the next message. Accordingly, the user is presented with the pre-defined configuration routine of messages until the user selects the user's preferred message or the configuration routine is exhausted. This procedure is performed iteratively according to the configuration routine. Alternatively, in another embodiment, the called party records his/her own message. In another embodiment, the called party instructs the mobile device 100 to select a ring, which sounds different from a standard ring to the caller. At step 210, the selected message is played to the caller. In another embodiment, the user selects a message or records a custom message that is hosted by the service provider.

Operation from Service Provider Viewpoint

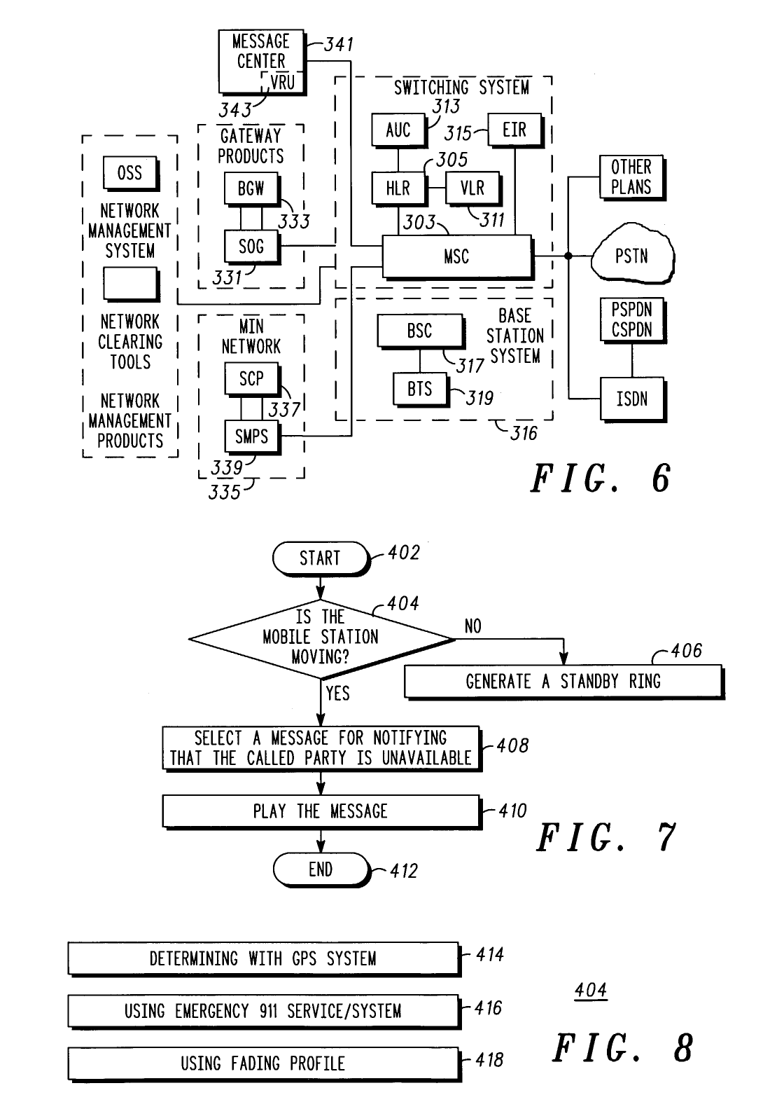

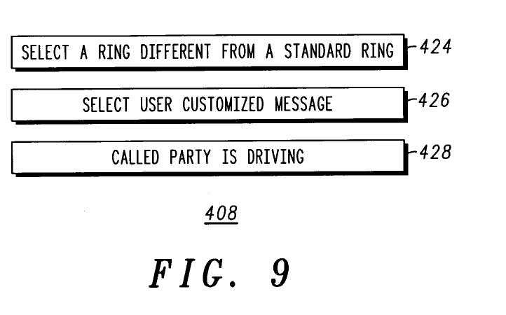

FIGS. 3A-3B are schematic and block diagrams of a service provider's network (such as Verizon; Bellsouth), in communication with and operating on the end user device of FIG. 1, for implementing the method, according to the present invention. FIGS. 4A-4C are flow diagrams showing the method (from a service provider's viewpoint), operating on the network of FIG. 3, according to the present invention.

Referring specifically to FIGS. 3A-3B, a plurality of mobile switching centers (MSC) 303 are shown which connect the mobile radiotelephone system to the public switched telephone network 301 (PSTN). The switching of the MSCs 303 interconnects a plurality of base stations (BS) 310, each of which provide service to a cell coverage area. Each coverage area is shown as having irregular boundaries typical of an actual system. Each BS 310 has radio transmit/receive equipment and radiating antennas to serve the mobile device 100 (located in the vehicle 350) within its cell coverage area.

In accordance with one embodiment, when the caller initiates a call to the called party (mobile device user 350), the service provider's network (e.g., Verizon) receives and processes the call. At step 404, the service provider's network determines if the mobile device 100 is in one of a defined “home” location 320 and “work” location 322. If so, the called party receives the phone call in a standard way as shown in step 406. Otherwise (i.e., if in one of locations 314, 318, 324, 326) the call is processed as shown in step 408. This helps define the locations in which a normal phone call is permitted.

In accordance with another embodiment, when the caller initiates a call to the called party (mobile device user 350), the service provider's network (e.g., Verizon) receives and processes the call. At step 404, the service provider's network determines if the mobile device 100 is moving.

It is important to note that although a AMPS and/or D-AMPS cellular phone system is described here other phone system such as CDMA, GSM, iDEN, UMTS and others are within the true scope and spirit of the present invention and the type of phone system is not limiting.

Flow Diagram with GPS Location Embodiment

In one embodiment, the determining step 404 is performed by a GPS system (at step 414) that computes the geographic coordinates (and detects the changes) of the mobile device. The GPS system is, for example, provided by a commercial supplier such as General Motors, and is coupled with the service provider's network as described in the above-section entitled “Location Embodiment Using GPS Receiver Hardware”.

Flow Diagram with E911 Location Embodiment

In another embodiment, the determining step 404 is performed by an E911 service/system (at step 416) that computes the geographic coordinates (and detects the changes) of the mobile device.

With reference to E911 system, Phase H of the Federal Communications Committee's Enhanced 911 (E911) mandate requires wireless carriers, including cellular licensees, broadband Personal Communications Service (PCS) licensees, and certain Specialized Mobile Radio (SMR) licensees, to provide Automatic Location Identification (ALI) as part of Phase II E911 implementation beginning Oct. 1, 2001. These carriers must modify their handsets and/or networks to meet the following location accuracy:

For handset-based solutions: 50 meters for 67 percent of calls, 150 meters for 95 percent of calls; and

For network-based solutions: 100 meters for 67 percent of calls, 300 meters for 95 percent of calls.

Since 1996, 911 calls can be placed on a wireless device without charge and or requirement of a service plan from any provider. Wireless 911 calls can be made on analog cellular phone or dual or tri-mode phones anywhere there is an analog network. However, before Phase II of E911, callers must provide the emergency operator their location and situation.

Flow Diagram with Fading Profile Location Embodiment

In another embodiment of the present invention, the determining step 404 is performed by a fading profile technique (at step 419).

Referring to “fading profile” and “multipath”, the behavior of a mobile radio signal in the general environment is complicated. Efforts to perform correlation between radio signals and distance between a base station and a mobile device are similarly complex. Because there are obstacles and reflectors in the wireless propagation channel, the transmitted signal arrivals at the receiver from various directions over a multiplicity of paths. Such a phenomenon is called multipath. It is an unpredictable set of reflections and/or direct waves each with its own degree of attenuation and delay.

Multipath is usually described by:

Line-of-sight (LOS): the direct connection between the transmitter (TX) and the receiver (RX).

Non-line-of-sight (NLOS): the path arriving after reflection from reflectors.

Multipath causes amplitude and phase fluctuations, and time delay in the received signals. Diversity schemes can be used to combat multipath. When the waves of multipath signals are out of phase, reduction of the signal strength at the receiver can occur. One such type of reduction is called the multipath fading; the phenomenon is known as “Rayleigh fading” or “fast fading.”

In an environment where multipath interference is significant, it is possible to mistakenly identify a strong multipath signal as the direct path signal. Since a multipath signal travels along an indirect path between the transmitter and receiver, the signal propagation time and, hence, the observed range differ from that of the direct path. In a position determining system relying on precise measurements of direct-path signal propagation time to determine range, erroneously interpreting a multipath signal as the direct path signal can drastically degrade performance. In particular, a multipath signal may result in a severely erroneous range measurement; nevertheless, if the multipath signal has a relatively high signal-to-noise ratio, the erroneous range measurement will be reported to a tracking filter as being highly accurate. Consequently, the filter will be misled into placing a high degree of reliance on a severely erroneous range measurement, thereby degrading the accuracy of the position estimate without the degraded accuracy being immediately known or reported.

In U.S. Pat. No. 6,486,831 to Martorana, et al., range measurements useful for determining an object's position are screened and evaluated so that only acceptable range measurement are supplied to a tracking filter and used to update the position solution. Range measurements deemed to be unacceptable are identified by the screening process and discarded before the erroneous range measurements can corrupt or degrade the position solution. This patent is hereby incorporated by reference in its entirety.

Selecting a Message

If it is determined that the mobile device 100 is not moving, the call is processed in the normal manner by generating a standard ring (at step 406). If it is determined that the mobile device 100 is in a moving vehicle, a message is selected (at step 408) for notifying the caller that the called party is unavailable. The selected message is at least one of the following, as described above in the section entitled “Custom Message”: a ring (as heard by the caller) which is different from a standard ring (step 424); a user-customized message (step 426); and/or an automated standard message (step 428).

Service Provider Network Operation

The service provider's mobile switch 303 queries several databases before answering the call. For this purpose, the following components are selectively utilized by the service provider.

The HLR 305 stores complete local information. It is the main database. The service provider puts the user's information on its nearest HRL, or the one assigned to the user's area. That info includes an international mobile equipment identity number or IMEI, a directory number, and the class of service. It also includes the user's current city and the last known “location area”, the place that the user last used the mobile device 100.

The VLR (visitor location registry) 311 contains roamer information. While roaming, once the visited system detects the user's mobile device 100, its VLR 311 queries the user's assigned home location register 305. The VLR 311 ensures that the user is a valid subscriber, and then retrieves just enough information from the now distant HLR 305 to manage the call. It temporarily stores information about the last known location area, the power the mobile uses, and special subscribed-services. Though traveling, the cellular network now knows where the mobile device 100 is and can direct calls to the mobile device 100.

The AUC (Authentication Center) 313 is a secured database that handles authentication and encryption keys. GSM, PCS 1900, and certain cellular systems support these features. The Authentication Center 313 verifies a mobile customer with a complex challenge and reply routine. The network sends a randomly generated number to the mobile device 100. The mobile device 100 then performs a calculation against it with a number it has stored and sends the result back. Only if the switch gets the number it expects does the call proceed. The AC 313 stores all data needed to authenticate a call and to then encrypt both voice traffic and signaling messages.

The EIR (Equipment Identity Register) 315 is another database. The EIR 315 lists stolen phones, fraudulent telephone identity numbers, and faulty equipment. It's a tool to deny service or track problem equipment.

The base station system 316 includes a base station controller (BSC) 317 and individual base transceiver stations (BTS) 319, which are also called “base stations”.

The service order gateway (SOG) 331 is a service desk, where clerks access network databases. Operators enter and cancel accounts and do administrative chores. The billing gateway (BGW) 333 is where customer and administrative billing information contacts the individual carrier.

The mobile intelligent network (MIN) 335 includes the service control point (SCP) 337, and the service management system (SMAS) 339. SMAS 339 provides service management functions. The 800-number lookup services, calling card services, calling number identification, short message service, message waiting indicator, and debit card services are provided through databases linked to the cellular system by the MIN 335.

Specific Message Customization by Service Provider/User

In this embodiment, the service provider provides message customization. The Message Center 341 stores and forwards voice, fax and electronic mail, as well as short texts from paging networks. In one embodiment, the Message Center also contains a Voice Response Unit (VRU) 343, which is also called an Interactive Voice Response unit (IVR). Through this, the user communicates with the service provider's network for the customization of messages. The customization of the messages is done by the user (“called party”) as follows. The user is presented by the Message Center 341 with a pre-defined configuration routine of messages. When the first message that is presented (via the audio output module 103 and transducer 105) is not satisfying to the user, the user informs the controller 102 via the keyboard 107 that the user needs more choice. Then, the controller 102 communicates with the Message Center 341/VRU 343 and executes the instructions for receiving the next message. Then, the user is presented (via the audio output module 103 and the transducer 105) with the next message. Accordingly, the user is presented with the pre-defined configuration routine of messages until the user selects the user's preferred message or the configuration routine is exhausted. This procedure is performed iteratively according to the configuration routine.

Alternatively, in another embodiment, the called party 350 records his/her own message, as described in the above-section entitled “Custom Message”.

In yet another embodiment, the called party instructs the Message Center 341 to select a ring, which sounds different from a standard ring to the calling party. At step 210, the selected message is played to the calling party.

Non-Limiting Hardware/Software Embodiments

The mobile device 100 and service provider platform in FIG. 3 can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after one or more of the following: a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method of reducing distractions of a mobile device user, the method by a mobile service provider comprising:
determining, if a mobile device is moving; and
if the mobile device is moving, then selecting a message for notifying a caller that a called party is unavailable.

2. The method of claim 1, wherein determining if the mobile device is moving includes checking with a GPS system if coordinates are changing within a given limit.

3. The method of claim 1, wherein determining if the mobile device is moving is performed by a fading profile technique.

4. The method of claim 1, wherein determining if the mobile device is moving is performed by using an E911 service.

5. The method of claim 1, wherein selecting the message includes choosing from a predefined mailbox of voice messages.

6. The method of claim 1, wherein the selected message is a customized message.

7. The method of claim 1, wherein the selected message includes a ring different from a standard calling ring.

8. The method of claim 5, wherein the predefined mailbox includes a message informing the caller that the called party is driving.

9. The method of claim 1, further comprising playing the selected message.

10. A method of reducing distractions of a mobile device user, the method on a mobile device comprising:
determining, if a mobile device is moving in a given region; and
if the mobile device is moving, then selecting a message for notifying a caller that a called party is unavailable.

11. The method of claim 10, wherein determining if the mobile device is moving includes checking with a GPS receiver if coordinates are changing within a given limit.

12. The method of claim 10, wherein determining if the mobile device is moving includes detecting an acceleration of the mobile device with an accelerometer.

13. The method of claim 10, wherein determining if the mobile device is moving includes sensing a vibration of the mobile device with a vibration sensor.

14. The method of claim 10, wherein selecting the message includes choosing from a mailbox of predefined voice messages.

15. The method of claim 10, wherein the selected message is a customized message.

16. The method of claim 10, wherein the selected message includes a ring different from a standard calling ring.

17. The method of claim 14, wherein the mailbox includes a message informing the caller that the called party is driving.

18. The method of claim 10, further comprising playing the selected message.

19. A mobile device, comprising:
a controller;
a detector coupled to the controller for detecting if the mobile device is moving in a given region; and
means for selecting a message for notifying a caller that a called party is unavailable.

20. The mobile device of claim 19, wherein the detector is a GPS receiver.

21. The mobile device of claim 19, wherein the detector is an accelerometer for detecting an acceleration of the mobile device.

22. The mobile device of claim 19, wherein the detector is a vibration sensor for sensing a vibration of the mobile device.

23. A computer readable medium comprising computer instructions for performing a method of reducing distractions of a mobile device user, the method on a mobile device comprising:
determining, if a mobile device is moving in a given region; and
if the mobile device is moving, then selecting a message for notifying a caller that a called party is unavailable.

24. The computer readable medium of claim 23, wherein determining if the mobile device is moving includes checking with a GPS receiver if coordinates are changing within a given limit.

25. The computer readable medium of claim 23, wherein determining if the mobile device is moving includes detecting an acceleration of the mobile device with an accelerometer.
